(19) United States
(12) Patent Application Publication
(10) Pub. No.: US 2025/0050453 A1
(43) Pub. Date: Feb. 13, 2025

(54) Active Transmission Measurement of Optical Metasurface during Etch Removal Process

(71) Applicant: GAMDAN Optics, Inc., San Jose, CA (US)

(72) Inventors: Thomas C Hutchens, San Jose, CA (US); Hui Cai, San Jose, CA (US); Lawrence B. Fischel, San Jose, CA (US)

(21) Appl. No.: 18/776,577

(22) Filed: Jul. 18, 2024

Related U.S. Application Data
(60) Provisional application No. 63/514,288, filed on Jul. 18, 2023.

(51) Int. Cl. B23K 26/362; G01N 21/59

(52) U.S. Cl. CPC B23K 26/362; G01N 21/59; G01N 2201/0227; G01N 2201/0636

(57) ABSTRACT

Embodiments of the present disclosure include techniques for forming metasurfaces on optical materials. In one embodiment, light is generated by a light source and coupled through an optical material including a metasurface during an etching process to form the metasurface. Transmission through the optical material and metasurface is performed during the etching process to maximize the transmission of the metasurface. The present disclosure includes apparatuses and method for forming metasurfaces on optical materials.

### CROSS REFERENCE TO RELATED APPLICATIONS

This application claims priority to U.S. Patent Provisional Application Ser. No. 63/514,288, filed on Jul. 18, 2023, the disclosure of which is hereby incorporated herein by reference.

### BACKGROUND

The present disclosure relates generally to manufacturing optical crystals, and in particular, to systems and methods for performing optical transmission measurements during processing of anti-reflective optical surfaces. In one example embodiment, the present disclosure pertains to In Situ Optical Transmission Measurement for Development and End-point Detection during Plasma Etching of Anti-Reflective Nano-Structured Surface Layers.

A typical method for reducing Fresnel reflection from an optical surface or planar interface is to apply a thin film, or anti-reflection coating to the surface. However, for higher optical energy transmission applications sometimes a nano-structuring of the surface can provide reduced reflection and higher laser damage threshold. This surface treatment is referred to as an Anti-Reflective Structured Surface (ARSS).

The present disclosure is directed to techniques for measuring optical transmission during the processing of optical structures with anti-reflective surface structures.

### BRIEF DESCRIPTION OF THE DRAWINGS

FIG. 1 illustrates an apparatus and method of forming an optical metasurface according to an embodiment.

FIG. 2 illustrates an example configuration for an apparatus and method of forming an optical metasurface according to an embodiment.

FIG. 3 illustrates an example configuration for an apparatus and method of forming an optical metasurface according to another embodiment.

FIG. 4 illustrates an example configuration for an apparatus and method of forming an optical metasurface according to yet another embodiment.

FIG. 5 illustrates forming an optical metasurface using multiple wavelengths of light according to an embodiment.

FIG. 6 illustrates an example configuration for an apparatus and method of forming an optical metasurface using optical fibers according to an embodiment.

FIG. 7 illustrates an example configuration for an apparatus and method of forming an optical metasurface using optical fibers according to another embodiment.

FIG. 8 illustrates an etch chamber according to another embodiment.

### DETAILED DESCRIPTION

Described herein are techniques for forming optical metasurfaces. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

The optical properties of an object, including a lens or an optical component, are determined by its atomic structure. Optical materials, such as optical crystals, may exhibit reduced reflection when metasurfaces are fabricated on a surface. Accordingly, metasurfaces on optical materials are useful for reducing reflection of the optical material, which may overcome limitations of thin films, for example. Metasurfaces are planar structures comprising micro and/or nano scale structures formed on the surface of an optical material to modify the propagation and scattering of electromagnetic waves directed at the surface. Such structures may be formed using a plasma or ion beam etch process. Metasurfaces on optical materials with the purpose of enhancing transmission are sometimes referred to as an Anti-Reflective Structured Surface (ARSS).

In some example applications, if the optical transmission is desired to be in the visible to near-infrared regime (400-1500 nm), to reduce scattering, it may be advantageous to have the ARSS individual feature widths less than ˜300 nm, and depth of same order or deeper. Deeper features may provide better optical performance as the effective gradient refractive index transition the light wave experiences is extended. However, too deep and the ARSS structures become mechanically unstable. Various embodiments described herein may include aspect ratios (e.g., width:depth) of greater than 0.5 in some embodiments, where aspect ratios 1:1 to 1:5 may be used in some cases. At the micron scale this is a much higher aspect ratio than a machine roughened or polished surface. Accordingly, anisotropic plasma or ion beam etching may be used. Additionally, while the optical materials and surfaces illustrated in the following figures show substantially long flat surfaces of wafer-like structures, it is to be understood that the dimensions of the optical materials may be a variety of shapes (e.g., where the length of the top and bottom surfaces are less than the thicknesses).

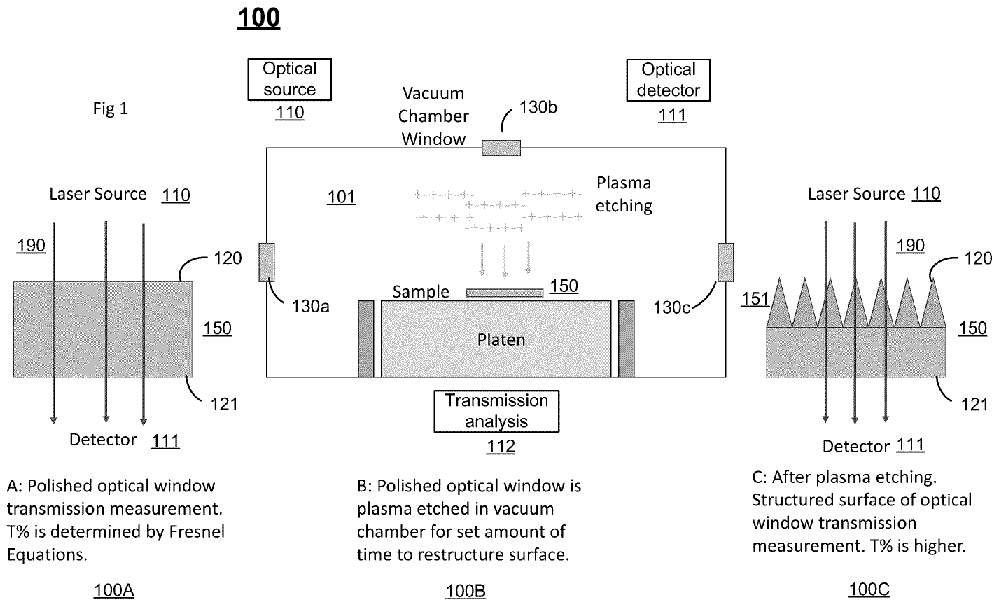

ARSS can be formed on an optical surface via dry plasma or ion beam etching with or without an etch resistant masking layer. FIG. 1 illustrates an apparatus and method for forming metasurface on an optical material according to an embodiment. Apparatus 100 comprises etch chamber 101. In various embodiments, etch chamber 101 may be an etch chamber configured to perform reactive ion etching (RIE), inductively coupled plasma (ICP) etching, ion beam etching (IBE), reactive ion beam etching (RIBE), simple plasma etching, or chemical dry etching, for example. Features and advantages of the present disclosure include an etch chamber configured with an optical source 110 (e.g., a laser) and optical detector 111 to pass a light 190 through an optical material 150, such as an optical crystal. The etch chamber 101 may comprise a vacuum chamber with one or more windows 130a-c, for example, where the light passes through the one or more windows between the optical source 110 and the optical detector 111. For example, in a plasma etch chamber, the pressure range may be in the range of 1-100 Pascals (Pa) or 7.5-750 milliTorr (mT).

Features and advantages of the present disclosure include measuring transmission of light through an optical material 150 during the etch process while at least one metasurface 151 is being formed. A peak transmission through the optical material may be determine in real time to optimize the resulting metasurface and the process, or both, for example. An initial optical crystal 150 is shown at 100A at the beginning of an etch process. After etching, the optical material 150 forms a metasurface 151 as illustrated at 100C. Light is passed through the optical material during the etch to monitor the transmissivity of the material. As the etch continues, the transmission increases to a maximum transmission, and then may start to decrease as over-etching degrades transmission performance, for example. Features and advantages of the present disclosure may sense a maximum transmission of the light to help optimize process development and/or stop the process (e.g., set an end-point), for example.

Accordingly, etch chamber 101 may comprise an optical source 110 (e.g., a laser) configured to generate a light having one or more wavelengths. In some embodiments, a single wavelength may be used. In other embodiments, multiple wavelengths may be used. An optical material 150 comprises a first surface 120 and a second surface 121, where the second surface 121 is opposite the first surface 120. The first surface 120 comprises metasurface 151. Optical material 150 is configured to couple the light 190 through the optical material 150 including the first surface 120 and the second surface 121. In other words, as illustrated in FIG. 1, light 190 passes through both the upper and lower surfaces. An optical detector 111 is configured to detect the light 190 transmitted through the optical material 150. Optical source 110 generates the light 190 during a metasurface etch process to form the metasurface 151, and the optical detector 111 senses a transmittance of the light (e.g., a received power) through the optical material during the metasurface etch process. For example, transmission analysis unit 112 may receive the transmitted power from the optical source 110 and a received power in the optical detector 111 and determine transmission of the optical material during etching.

In various embodiments, the system may detect increases in the transmission as the etch process proceeds and determine a peak on the transmission after the transmission increases and then starts to decrease, for example. Accordingly, in some embodiments, the system is configured to detect a maximum transmittance of the light through the optical material during the metasurface etch process. In some embodiments, the system may be configured to detect a maximum transmittance of the light through a plurality of optical materials (e.g., multiple samples) during a plurality of metasurface etch processes. Data for forming a metasurface on an optical material may be compiled across multiple processes and samples, for example, and used to detect both the peak transmission as well as the process time for various process recipes, for example, to optimize an etch process. In some embodiments, the system may be configured to set a predefined maximum transmittance of the light for an endpoint of the metasurface etch process based on the maximum transmittance for the plurality of optical materials during the plurality of plasma etch processes. An endpoint may be a transmittance where, when detected, the etch process is automatically halted, for example, after the metasurface is etched to obtain a peak transmission for the optical material.

Referring again to metasurface layer 151, in some embodiments this layer can be formed via photolithography or randomly sputtered metal/material on the surface prior to plasma etching, for example. Reactive ion etching (FIG. 1-B at 100B), or inductively coupled plasma etching, for example, uses a vacuum chamber (˜10-100mT) and electrode (50-2000W) to ionize reactive and non-reactive gas species (e.g., typically, Fluorine based, CHF3, SF6, C4F8, CF4, O2, Ar) in the chamber and accelerate them at the sample facilitating an anisotropic etching of the sample surface. The etch time for ARSS formation may be in the range of 3-60 min, for example, depending on substrate material and plasma hardware and etching recipe. This etch time may be set based on previous trials on similar sample and plasma etching system configurations as mentioned above. However, variations in sample geometry or plasma etcher tolerances can lead to variations in ARSS performance. Optical transmission measurement determines the post process performance functionality of the final product but currently cannot be done outside of the process. As it is difficult to simulate and predict the actual transmission performance as the process progresses, embodiments of the present disclosure may advantageously capture the optimal performance point to end the process, for example. The ability to capture this metric in-situ may greatly speed up the ARSS development process on all transmissive optical components.

Optical transmission performance (T %) of a transparent sample can be measured before (FIG. 1-A at 100A) and after (FIG. 1-C at 100C) this plasma etching step to confirm ARSS and T % enhancement. For example, a polished double-sided silica (SiO₂) window will exhibit ˜92% T in the visible light range, but after fabricating ARSS on a single side the transmission is enhanced to ˜96% T, and if both sides are treated, ˜100% T. This transmission can be measured with a single wavelength laser or as a spectrum with a spectrometer using multiple wavelengths, as mentioned above.

Some embodiments of the present disclosure measure the optical transmission through the sample during the etching step (in-situ) as a means for end-point detection in the process of creating an ARSS. The T % can be monitored in situ and the plasma etching step halted when the desired T % performance is achieved, for example. The T % can be measured while the sample is in the etching chamber (e.g., a plasma etching chamber before the plasma is ignited and during the plasma etching step) to compensate for any T % change through the plasma field. Other potential uses of the method are bulk material transmission measurements, wavefront distortion, and sample temperature. Optical materials that may be used include any transmissive optical components made of various materials such as Silica, Silicon, Sapphire, LBO, and BBO . . . , etc.

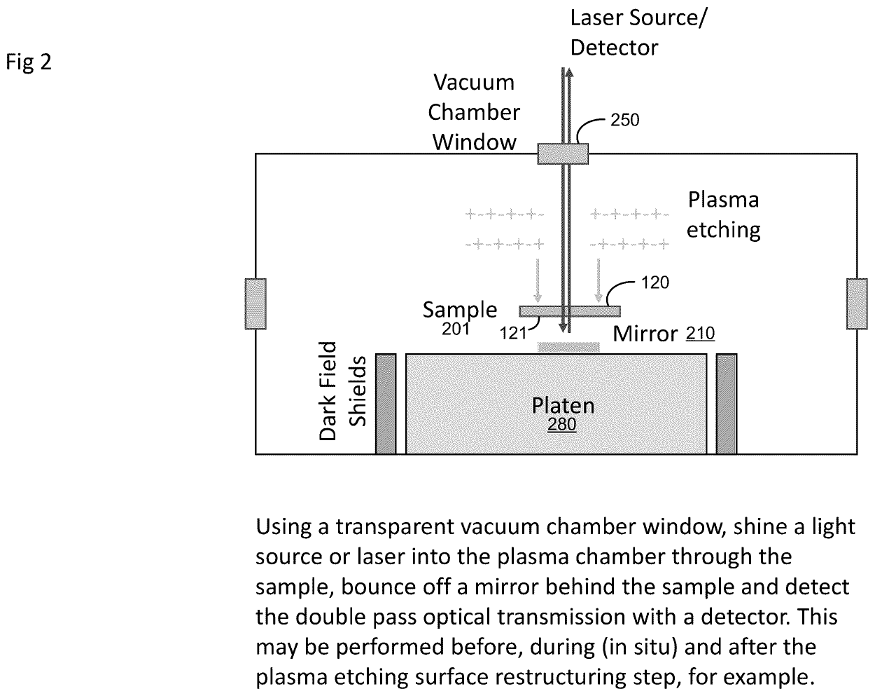

Processes and apparatuses detailed in FIGS. 2-8 are non-limiting example systems and method for performing the present techniques.

FIG. 2 illustrates the addition of a mirror 210 underneath the optical material sample 201. In this example, light enters and exits the chamber through window 250. Light is coupled to the top surface 120, and a portion of the light is transmitted through the material. A mirror 210 is configured (e.g., on platen 280) to reflect the light from the second surface 121 back to the second surface 121, back through the optical material 210, and out of the first surface 120. The light then passes back through window 250 to a light detector. Using a transparent vacuum chamber top window, a light source or laser points into the plasma chamber through the sample, retro-reflects off a mirror behind the sample and the double pass optical transmission is measured with a detector. This may be performed before, during (e.g., for end-point detection (in situ)), and after the plasma etching surface restructuring step, for example.

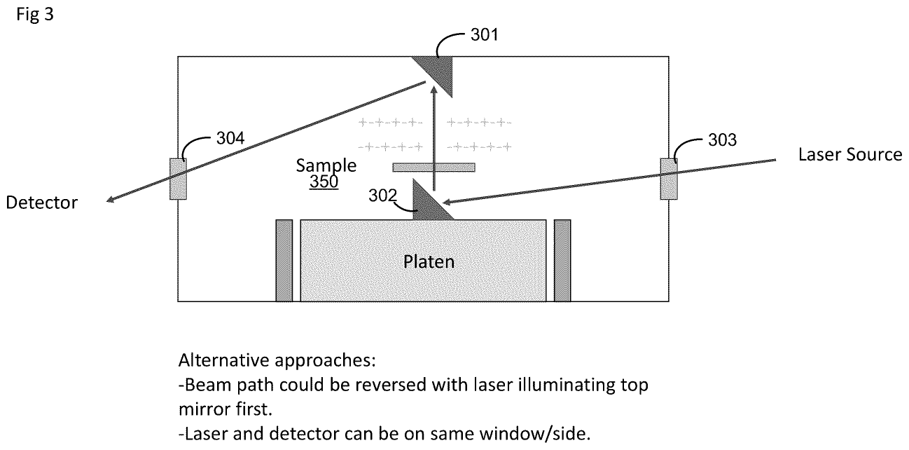

FIG. 3 illustrates an alternate configuration. As mentioned above, in various embodiments, light may pass from the surface including the metasurface (typically the top surface), through the optical material, and out the opposite surface, or light may pass into the optical material from under the metasurface (e.g., into the surface opposite the metasurface, through the optical material, and out through the metasurface). In this example, a first mirror 302 is configured to reflect the light from the optical source to the bottom surface and a second mirror 301 is configured to reflect the light out of the metasurface to the optical detector. More specifically, a light source enters a side vacuum window 303, is redirected by an angle mirror 302 up through the sample, reflects off another angle mirror 301 at the top of the chamber and out a side vacuum window 304 for detection. Alternatively, beam path could be reversed with laser illuminating top mirror first. In yet another embodiment, mirror 302 could be reversed so that the laser and detector can be on same side (e.g., input and output through window 304).

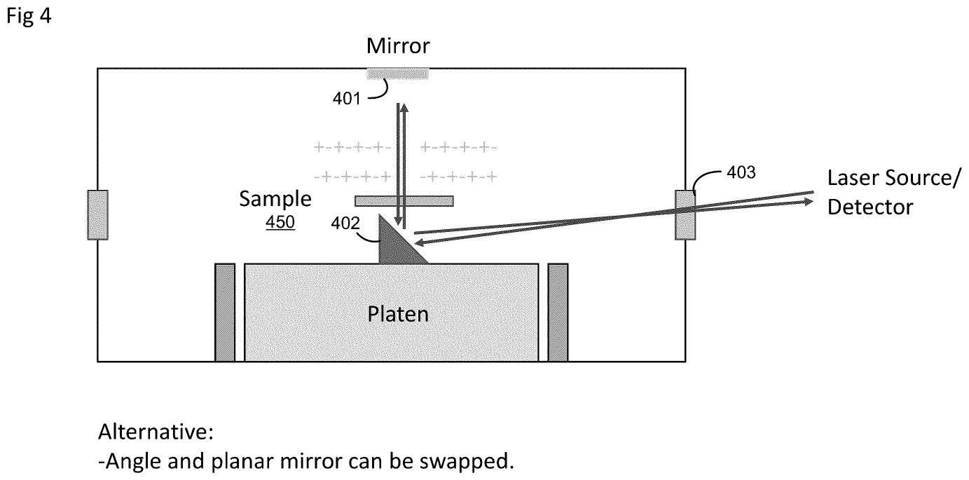

FIG. 4 illustrates another apparatus and method similar method to FIG. 3. In some embodiments, a first mirror 402 is configured to reflect the light from the optical source to one of the opposite surface of the metasurface, and a second mirror 401 is configured to reflect the light out of the other of the metasurface back to the optical material 450. Mirror 402 then reflects light from the optical material to the optical detector. In this example, the source and detector may enter through window 403 (although multiple windows could be used). Here, one of the angled mirrors from FIG. 3 is now a planar mirror, and the T % is a double pass measurement. Alternatively, the planar mirror 401 and angled mirror 402 can be swapped.

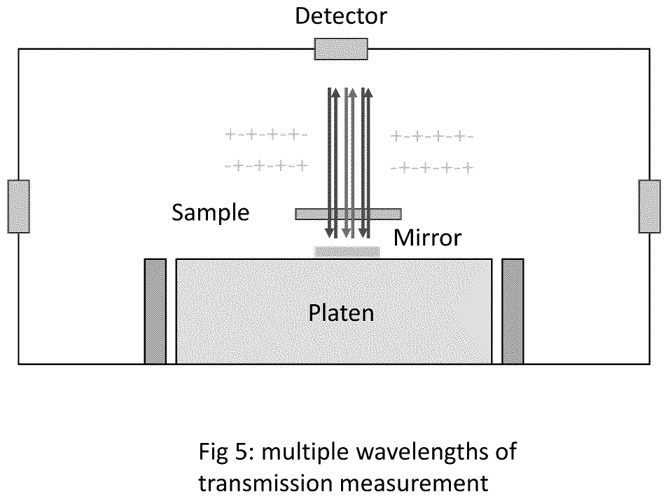

FIG. 5 illustrates that any method can alternatively be performed with a spectrometer as the detector and a broadband light source.

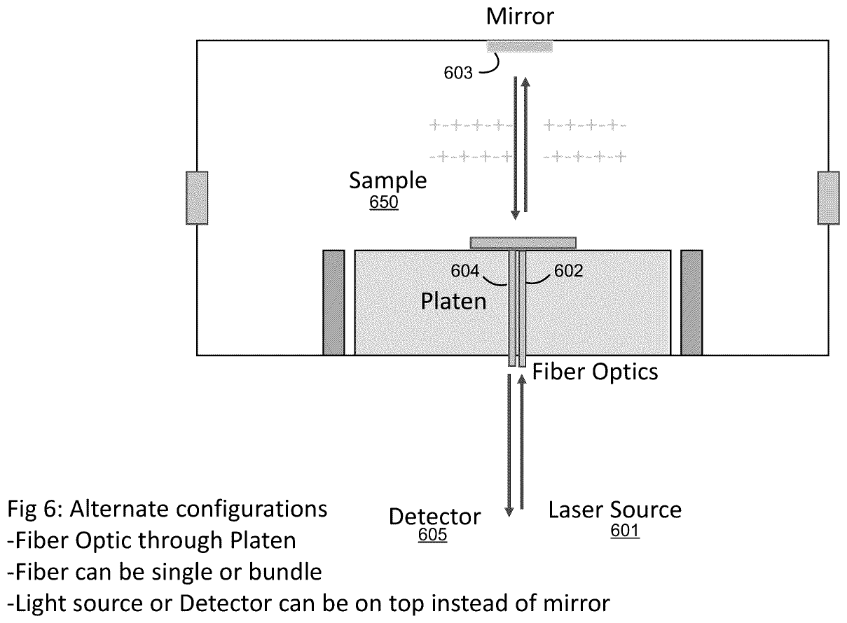

FIG. 6 illustrates another example embodiment. In some embodiments, the etch chamber comprises a fiber optic cable 602 coupled between the optical source (e.g., laser 601) and the optical material 650. In some embodiments, the etch chamber comprises a fiber optic cable 604 coupled between the optical material 650 and the optical detector 605. In this example embodiment, modification to the platen or lower electrode are made to allow a fiber optic cable 602 to deliver light from laser source 601 to underneath the sample 650 for illumination and/or detection. Alternatively, the fiber can also be a fiber bundle and/or the light source or detector can be on the top of the chamber, for example.

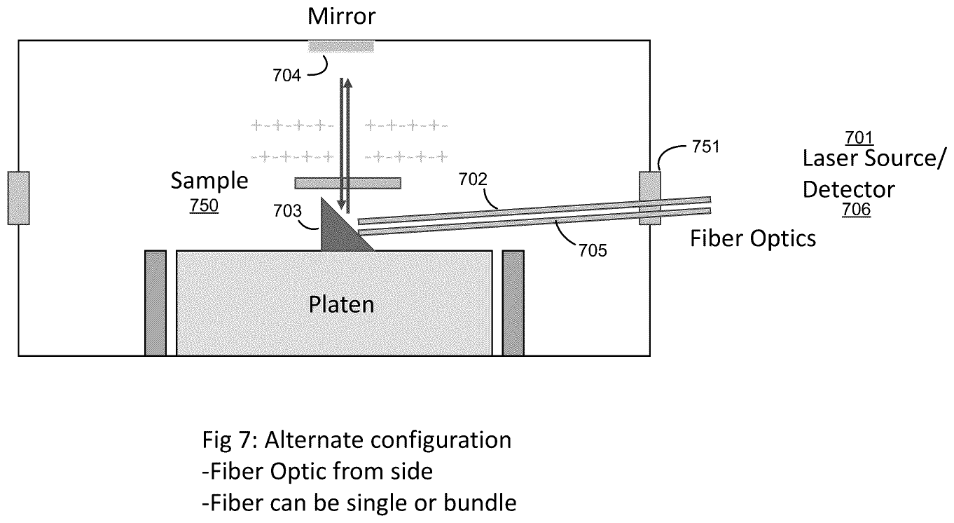

FIG. 7 illustrates another example embodiment using fiber optic cables. This example is a modification of FIG. 4, but the light source and/or detector are sent through a side port via fiber optic cable. Here, a laser source 701 generates light, which is coupled to fiber 702. Fiber 702 is configured through port 751 into the chamber and a distal end of the fiber is configure to output light to mirror 703. Mirror 703 is configured at an angle to redirect the light to a lower surface of optical material sample 750. Light passes through the bottom of sample 750, through the material from under the metasurface, and out the top surface. The light is reflected back to the metasurface of sample 750 by mirror 704, and coupled into a distal end of fiber 705 by mirror 703. Fiber 705 is coupled through the chamber wall via port 751 to detector 706, for example. It is to be understood that separate mirrors and ports could be used for fibers 702 and 705, and the present embodiment is merely an example.

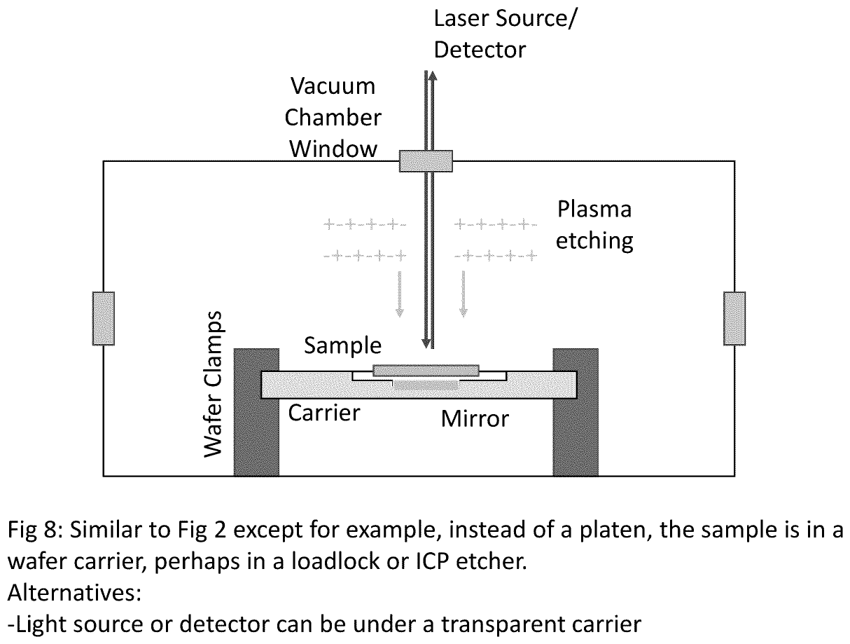

FIG. 8 illustrates another example according to an embodiment. In this example, the sample is on a wafer carrier. In some embodiments, the base under the sample may be in a loadlock or IPC etcher, for example. The optical sources and detectors may be configured according to any of the above configurations for detection, but here the sample is etched in an inductively couple plasma (ICP) etching chamber or wafer clamping chamber. In this case the wafer is replaced with a sample carrier with mirror underneath the sample. Alternatively, the light source and/or detector can be under a transparent sample carrier.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

In one embodiment, the present disclosure includes an apparatus comprising: an etch chamber; an optical source configured to generate a light having one or more wavelengths; at least one optical material comprising a first surface and a second surface, wherein the second surface is opposite the first surface, the first surface comprising a metasurface, the optical material configured to couple the light through the optical material including the first surface and the second surface; and an optical detector configured to detect the light transmitted through the optical material, wherein the optical source generates the light during a metasurface etch process to form the metasurface, and the optical detector senses a transmittance of the light through the optical material during the metasurface etch process.

In one embodiment, the present disclosure include a method of forming an anti-reflective metasurface on an optical material comprising: in an etch chamber, generating, by an optical source, a light having one or more wavelengths during an anti-reflective metasurface etch process to form the anti-reflective metasurface; coupling the light through the optical material including a first surface of the optical material and a second surface of the optical material, wherein the second surface is opposite the first surface, the first surface comprising the anti-reflective metasurface, the optical material configured to couple the light through the optical material including the first surface and the second surface; sensing a transmittance of the light transmitted through the optical material in an optical detector during the anti-reflective metasurface etch process; and determining a maximum transmittance of the light transmitted through the optical material.

In one embodiment, the apparatus is configured to detect a maximum transmittance of the light through the optical material during the metasurface etch process.

In one embodiment, the apparatus is configured to detect an end-point of the metasurface etch process corresponding to a predefined maximum transmittance of the light through the optical material during the metasurface etch process.

In one embodiment, the apparatus is configured to detect a maximum transmittance of the light through a plurality of optical materials during a plurality of metasurface etch processes.

In one embodiment, the apparatus is configured to set a predefined maximum transmittance of the light for an endpoint of the metasurface etch process based on the maximum transmittance for the plurality of optical materials during the plurality of etch processes.

In one embodiment, the metasurface is an anti-reflective nano-structure surface.

In one embodiment, the metasurface is an anti-reflective micro-structure surface.

In one embodiment, the light comprises a single wavelength.

In one embodiment, the light comprises a plurality of wavelengths.

In one embodiment, the etch chamber comprises a vacuum chamber, the vacuum chamber comprising one or more windows, wherein the light passes through the one or more windows between the optical source and the optical detector.

In one embodiment, the light is received on the first surface and passes out of the second surface.

In one embodiment, the light is received on the second surface and passes out of the first surface.

In one embodiment, the techniques further comprising a mirror configured to reflect the light from the second surface back to the second surface, through the optical material, and out of the first surface.

In one embodiment, the techniques further comprising: a first mirror configured to reflect the light from the optical source to one of the first surface or the second surface; and a second mirror configured to reflect the light out of the other of the first surface or the second surface to the optical detector.

In one embodiment, the techniques further comprising: a first mirror configured to reflect the light from the optical source to one of the first surface or the second surface; and a second mirror configured to reflect the light out of the other of the first surface or the second surface back to the optical material, wherein the first mirror reflects light from the optical material to the optical detector.

In one embodiment, the etch chamber comprises a first fiber optic cable coupled between the optical source and the optical material.

In one embodiment, the etch chamber comprises a second fiber optic cable coupled between the optical material and the optical detector.

In one embodiment, the present disclosure includes a method comprising measuring the optical transmission through a sample during a plasma etching step to detect an end-point in the process of creating a reduced reflection and higher laser damage threshold nano-structure surface.

In one embodiment, the present disclosure includes an apparatus comprising means for measuring the optical transmission through a sample during a plasma etching step to detect an end-point in the process of creating a reduced reflection and higher laser damage threshold nano-structure surface.

In various embodiments, the present disclosure includes methods comprising measuring the optical transmission through a sample before, during, and/or after a plasma etching step to detect an end-point in the process of creating a reduced reflection and higher laser damage threshold nano-structure surface as illustrated in FIGS. 2-8.

In various embodiments, the present disclosure includes apparatuses comprising optical sources and detectors configured to measure the optical transmission through a sample during a plasma etching step to detect an end-point in the process of creating a reduced reflection and higher laser damage threshold nano-structure surface as illustrated in FIGS. 2-8.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. An apparatus comprising:
an etch chamber;
an optical source configured to generate a light having one or more wavelengths;
at least one optical material comprising a first surface and a second surface, wherein the second surface is opposite the first surface, the first surface comprising a metasurface, the optical material configured to couple the light through the optical material including the first surface and the second surface; and
an optical detector configured to detect the light transmitted through the optical material,
wherein the optical source generates the light during a metasurface etch process to form the metasurface, and the optical detector senses a transmittance of the light through the optical material during the metasurface etch process.

2. The apparatus of claim 1 wherein the apparatus is configured to detect a maximum transmittance of the light through the optical material during the metasurface etch process.

3. The apparatus of claim 2 wherein the apparatus is configured to detect an end-point of the metasurface etch process corresponding to a predefined maximum transmittance of the light through the optical material during the metasurface etch process.

4. The apparatus of claim 2 wherein the apparatus is configured to detect a maximum transmittance of the light through a plurality of optical materials during a plurality of metasurface etch processes.

5. The apparatus of claim 4 wherein the apparatus is configured to set a predefined maximum transmittance of the light for an endpoint of the metasurface etch process based on the maximum transmittance for the plurality of optical materials during the plurality of etch processes.

6. The apparatus of claim 1 wherein the metasurface is an anti-reflective nano-structure surface.

7. The apparatus of claim 1 wherein the metasurface is an anti-reflective micro-structure surface.

8. The apparatus of claim 1 wherein the light comprises a single wavelength.

9. The apparatus of claim 1 wherein the light comprises a plurality of wavelengths.

10. The apparatus of claim 1 wherein the etch chamber comprises a vacuum chamber, the vacuum chamber comprising one or more windows, wherein the light passes through the one or more windows between the optical source and the optical detector.

11. The apparatus of claim 1 wherein the light is received on the first surface and passes out of the second surface.

12. The apparatus of claim 1 wherein the light is received on the second surface and passes out of the first surface.

13. The apparatus of claim 1 further comprising a mirror configured to reflect the light from the second surface back to the second surface, through the optical material, and out of the first surface.

14. The apparatus of claim 1 further comprising:
a first mirror configured to reflect the light from the optical source to one of the first surface or the second surface; and
a second mirror configured to reflect the light out of the other of the first surface or the second surface to the optical detector.

15. The apparatus of claim 1 further comprising:
a first mirror configured to reflect the light from the optical source to one of the first surface or the second surface; and
a second mirror configured to reflect the light out of the other of the first surface or the second surface back to the optical material,
wherein the first mirror reflects light from the optical material to the optical detector.

16. The apparatus of claim 1 wherein the etch chamber comprises a first fiber optic cable coupled between the optical source and the optical material.

17. The apparatus of claim 1 wherein the etch chamber comprises a second fiber optic cable coupled between the optical material and the optical detector.

18. A method of forming an anti-reflective metasurface on an optical material comprising:
in an etch chamber,
generating, by an optical source, a light having one or more wavelengths during an anti-reflective metasurface etch process to form the anti-reflective metasurface;
coupling the light through the optical material including a first surface of the optical material and a second surface of the optical material, wherein the second surface is opposite the first surface, the first surface comprising the anti-reflective metasurface, the optical material configured to couple the light through the optical material including the first surface and the second surface;
sensing a transmittance of the light transmitted through the optical material in an optical detector during the anti-reflective metasurface etch process; and
determining a maximum transmittance of the light transmitted through the optical material.

19. The method of claim 18 further comprising detecting an end-point of the metasurface etch process corresponding to a predefined maximum transmittance of the light through the optical material during the metasurface etch process.

20. The method of claim 18 further comprising detecting a maximum transmittance of the light through a plurality of optical materials during a plurality of metasurface etch processes, and wherein the apparatus is configured to set a predefined maximum transmittance of the light for an endpoint of the metasurface etch process based on the maximum transmittance for the plurality of optical materials during the plurality of etch processes.
